(19) United States
(12) Patent Application Publication
(10) Pub. No.: US 2019/0111634 A1
(43) Pub. Date: Apr. 18, 2019

(54) BATTERY POWERED CARPET SEAMER

(71) Applicant: TTI (MACAO COMMERCIAL OFFSHORE) LIMITED, Macau (MO)

(72) Inventors: Casey R. Izard, Easley, SC (US); Tanmay Kavathekar, Central, SC (US); Samuel Boyles, Easley, SC (US)

(21) Appl. No.: 15/783,840

(22) Filed: Oct. 13, 2017

(51) Int. Cl. B29C 65/00; D06F 75/24; D06F 75/26; D06F 75/34

(52) U.S. Cl. CPC B29C 66/9141; D06F 75/24; H02J 7/02; D06F 75/34; B29C 66/8612; D06F 75/26

(57) ABSTRACT

A carpet seamer including an iron, a handle, and a neck. The iron includes a base plate and a heater configured to transmit heat to the base plate. The handle has a first end and a second end opposite the first end. The second end faces a direction of travel of the carpet seamer when the carpet seamer is in operation. The neck connects the iron with a lower portion of the handle. The carpet seamer also includes a battery receiving portion positioned at the second end of the handle. The battery receiving portion is configured to receive a releasably attachable battery pack. The carpet seamer further includes a seamer electronic processor coupled to the heater. The seamer electronic processor is configured to control the heater to selectively receive power from the battery pack

### BACKGROUND

The present invention relates to carpet seaming irons, or carpet seamers.

### SUMMARY

In one embodiment, the invention provides a carpet seamer including an iron, a handle, and a neck. The iron includes a base plate and a heater configured to transmit heat to the base plate. The handle has a first end and a second end opposite the first end. The second end faces a direction of travel of the carpet seamer when the carpet seamer is in operation. The neck connects the iron with a lower portion of the handle. The carpet seamer also includes a battery receiving portion positioned at the second end of the handle. The battery receiving portion is configured to receive a releasably attachable battery pack. The carpet seamer further includes a seamer electronic processor coupled to the heater. The seamer electronic processor is configured to control the heater to selectively receive power from the battery pack

In another embodiment the invention provides a carpet seamer including an iron, a handle, and a seamer electronic processor. The iron includes a base plate and a heater configured to transmit heat to the base plate. The handle is coupled to the iron and includes a first portion substantially parallel to the base plate. The handle also includes a grip portion coupled to the first portion and positioned at a first oblique angle relative to the base plate, and a battery receiving portion coupled to the grip portion and the first portion and positioned at a second oblique angle relative to the base plate. The first oblique angle is different than the second oblique angle. The battery receiving portion is configured to receive a battery pack. The seamer electronic processor is coupled to the heater, and is configured to generate a control signal to control the heater to selectively receive power from the battery pack.

Other aspects of the invention will become apparent by consideration of the detailed description and accompanying drawings.

### BRIEF DESCRIPTION OF THE DRAWINGS

FIG. 1 is a perspective view of a battery powered carpet seamer.

FIG. 2 is a front cross-section of the battery powered carpet seamer of FIG. 1.

FIG. 3 is a bottom view of the battery powered carpet seamer of FIG. 1.

FIG. 4 is a side view of the battery powered carpet seamer of FIG. 1.

FIG. 5 is a back perspective view of the battery powered carpet seamer without a battery pack.

FIG. 6 is a perspective view of a carpet seaming system.

FIG. 7 is a block diagram of the carpet seaming system of FIG. 6.

FIG. 8 is a flowchart illustrating a method of operating the carpet seaming system of FIG. 6.

FIG. 9 is a flowchart illustrating a method of heating the carpet seamer of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

It should be noted that a plurality of hardware and software based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible. The terms “processor” “central processing unit” and “CPU” are interchangeable unless otherwise stated. Where the terms “processor” or “central processing unit” or “CPU” are used as identifying a unit performing specific functions, it should be understood that, unless otherwise stated, those functions can be carried out by a single processor, or multiple processors arranged in any form, including parallel processors, serial processors, tandem processors or cloud processing/cloud computing configurations. Additionally, the drawings illustrate particular angles and the text herein describes various angles. The particular angles illustrated and described are example of such angles, and some embodiments include variations in the particular angles, such as variances of plus or minus ten degrees. Additionally, “substantially” and “approximately,” when used herein with respect to angles (e.g., “substantially perpendicular”) are meant to allow for some slight deviation from the particular angle, such as plus or minus ten degrees. For example, substantially perpendicular is intended to describe angles between 80 and 100 degrees.

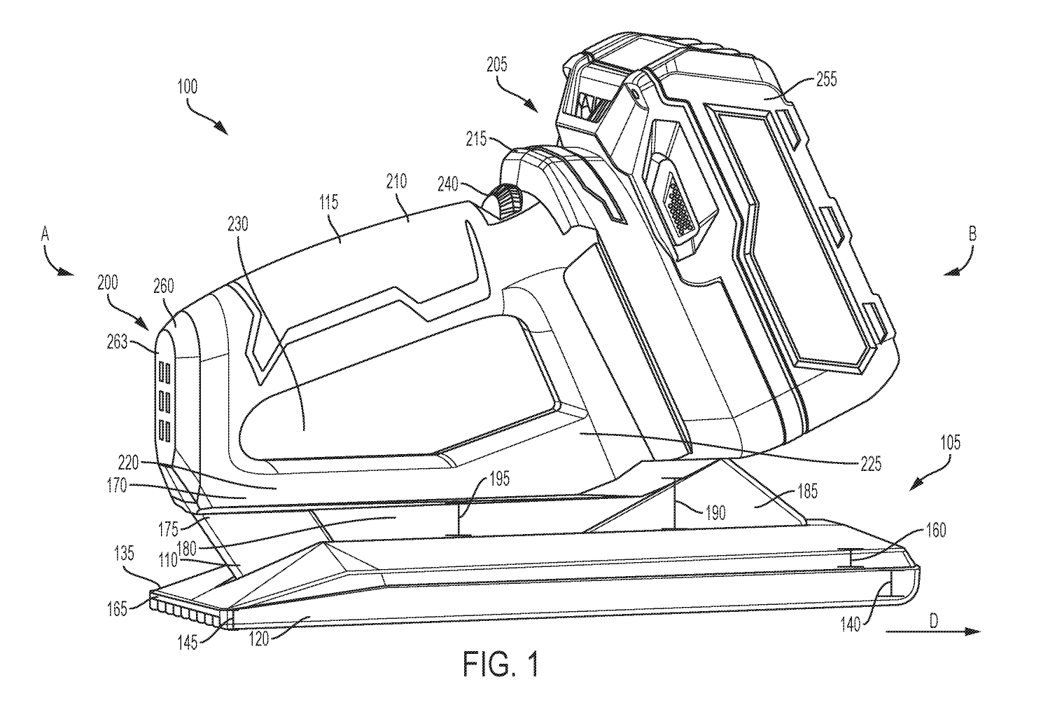

FIG. 1 illustrates a carpet seamer 100. The carpet seamer 100 is a battery powered carpet seamer used, for example, to join two pieces of carpet together with carpet seaming tape. During operation, the carpet seamer 100 will be placed on top of a first portion of carpet seaming tape. When the carpet seamer 100 properly heats the first portion of carpet seaming tape, a user moves the carpet seamer 100 onto a second portion of carpet seaming tape in the direction of arrow D toward a back side B of the carpet seamer 100. Meanwhile, the user presses two carpet pieces over the first portion of carpet seaming tape onto the carpet seaming tape on a front side A of the carpet seamer 100. A user continues heating portions of carpet seaming tape and pressing the carpet pieces onto the heated carpet seaming tape until the two pieces of carpet have been fully joined.

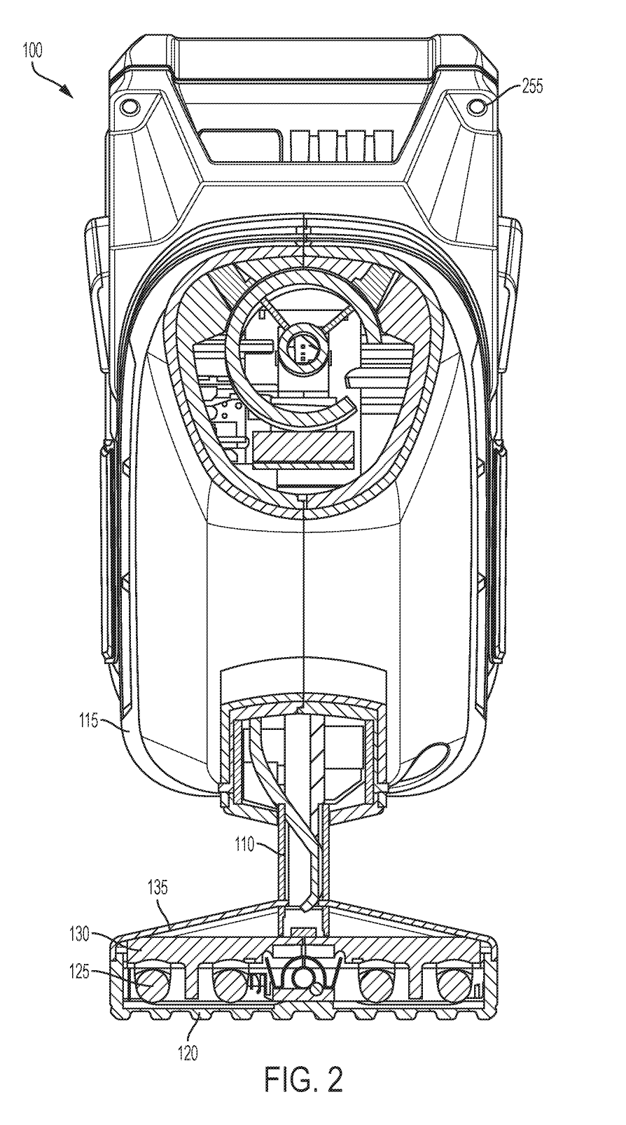

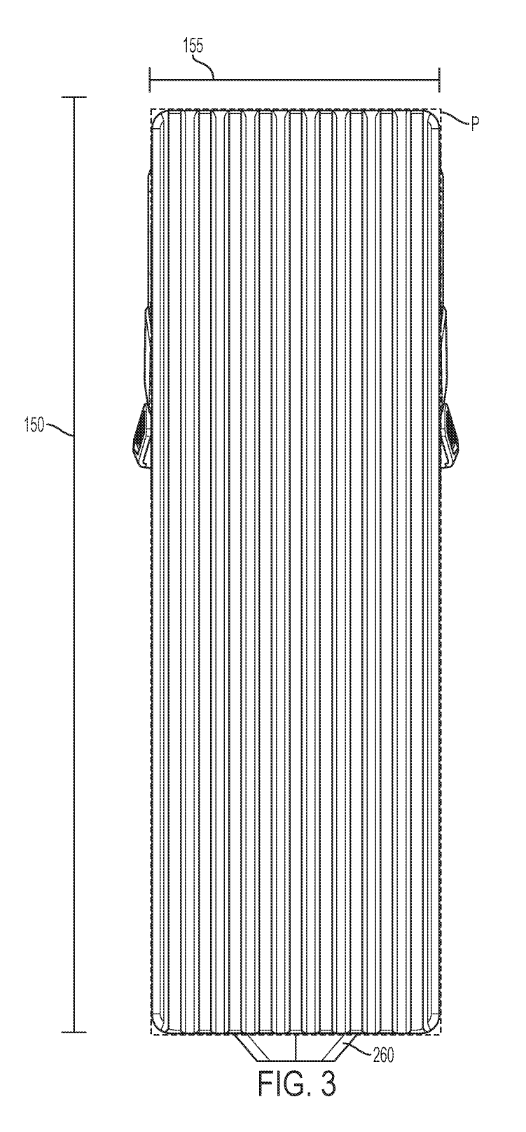

As shown in FIG. 1, the carpet seamer 100 includes an iron 105, a neck 110, and a handle 115. During operation, the iron 105 is placed over and heats the carpet seaming tape. The iron 105 includes a base plate 120, a heater 125 (see FIG. 2), an insulation layer 130 (see FIG. 2), and a top plate 135. In the illustrated embodiment, the base plate 120 is an aluminum plate. In other embodiments, the base plate 120 may be made from different materials that can adequately conduct heat. As shown in FIG. 1, the base plate 120 has a first height 140 at the back side B of the iron 105, and tapers toward a shorter second height 145 toward the front side A of the iron 105. In the illustrated embodiment, as shown in FIG. 3, a bottom surface of the base plate 120 is rectangular and includes a length 150 and a width 155. In the illustrated embodiment, the width 155 of the base plate 120 is approximately 2.5 inches to accommodate various sizes of carpet seaming tape. In other embodiments, the dimensions of the base plate 120 may be different. The base plate 120 also defines a perimeter P (see FIG. 3) of the iron 105. The perimeter P corresponds to the footprint of the carpet seamer 100. The base plate 120 is designed to withstand a maximum iron temperature threshold. In the illustrated embodiment, the maximum iron temperature threshold is approximately 400 degrees Fahrenheit, although the maximum iron temperature threshold may be different in different embodiments.

The heater 125 is positioned directly above the base plate 120 and transfers heat to the base plate 120. In the illustrated embodiment, the heater 125 includes a rigid strip heater including copper tubes. In other embodiments, different types of heaters may be used including, for example, flexible heaters. The heater 125 has a width approximately equal to the width of the base plate 120 such that even heating of the base plate 120 is provided by the heater 125. In the illustrated embodiment, the width of the heater 125 is approximately 2.5 inches such that the edges of the heater 125 abut the edges of the base plate 120. Due to heat loss experienced by the base plate 120, the heater 125 is designed or selected to withstand a maximum heater temperature threshold. The maximum heater temperature threshold is higher than the maximum iron temperature threshold discussed above. For example, when the maximum iron temperature threshold is approximately 400 degrees Fahrenheit, the maximum heater temperature threshold may be, for example, 480 degrees Fahrenheit. A higher maximum heater temperature threshold enables the heater 125 to provide sufficient heat to the base plate 120 despite the heat loss experienced by the base plate 120.

As shown in FIG. 2, the insulation layer 130 is added above the heater 125 to retain heat and inhibit further heat loss by the iron 105. In the illustrated embodiments, the insulation layer 130 includes a rigid calcium silicate insulation layer. In other embodiments, other types of rigid or flexible insulation may be used. Insulating the iron 105 reduces heat loss, which reduces energy consumption and may increase battery life. Accordingly, in the illustrated embodiment, the insulation layer 130 has a minimum heat flow rate (i.e., k-factor) of approximately 1.05 at 800 degrees Fahrenheit. In one embodiment, the insulation layer 130 and the heater 125 are secured to the base plate 120 via spring plates that engage two opposite edges of the base plate 120. For example, the spring plates may engage opposite edges along the length 150 of the base plate 120.

The top plate 135 covers the heater 125 and the insulation layer 130. Referring back to FIG. 1, the top plate 135 follows the contour of the base plate 120. Accordingly, the top plate 135 also includes a first height 160 on the back side B of the iron 105 and tapers to a second height 165 on the front side A of the iron 105. The tapering of both the base plate 120 and the top plate 135 allow the iron 105 to have a shorter height on the front side A of the iron 105. As the carpet seamer 100 is shifted in the direction of arrow D and the carpet pieces on the front side A of the iron 105 are pressed against the carpet seaming tape, the lower height on the front side A of the iron 105 inhibits the carpet pieces closest to the front side A of the iron 105 from being lifted away from the carpet seaming tape.

The neck 110 connects the iron 105 with the handle 115. As shown in FIG. 1, the neck 110 includes a thin metal piece connected to the top plate 135 and a base 170 of the handle 115. Typically, while the carpet seamer 100 heats the portion of carpet seaming tape, the two carpet pieces to be joined rest upon the top plate 135 and are separated by the neck 110. Accordingly, the neck 110 is designed to be thin to minimize the separation between the two carpet pieces to be joined. As illustrated in FIG. 2, the neck 110 has a thickness that is less than a thickness of the handle 115. The neck 110 follows the contour of the top plate 135 and the base 170 of the handle 115. In particular, the neck 110 includes a front neck portion 175, a middle neck portion 180, and a back neck portion 185, each portion having a different height. The front neck portion 175 includes a generally horizontal top and a downward slanted bottom to follow the sloping contour of the top plate 135. The middle neck portion 180 includes a generally horizontal top and a generally horizontal bottom. The back neck portion 185 includes a generally horizontal bottom and an upward slanted top. Accordingly, a height 190 of the back neck portion 185 is greater than a height 195 of the middle neck portion 180.

The handle 115 is configured to accept a user's hand and is used to control the carpet seamer 100 during a carpet seaming operation. In the illustrated embodiment, the handle 115 is made from a plastic material to insulate the user from the heat of the iron 105. The handle 115 includes a front end 200 that aligns with the front side A of the iron 105 and a back end 205 toward the back side B of the iron 105. As shown in FIG. 1, the handle 115 includes the base 170, a grip portion 210, and a battery receiving portion 215. The base 170 includes a first base portion 220 toward the front side A of the iron 105, and a rising base portion 225 toward the back side B of the iron 105. The first base portion 220 is generally parallel to the base plate 120 (e.g., horizontal). The front neck portion 175 and the middle neck portion 180 support the first base portion 220. The rising base portion 225, on the other hand, slopes upward (e.g., is at an acute angle relative to the base plate 120) to meet the battery receiving portion 215. The back neck portion 185 supports the rising base portion 225.

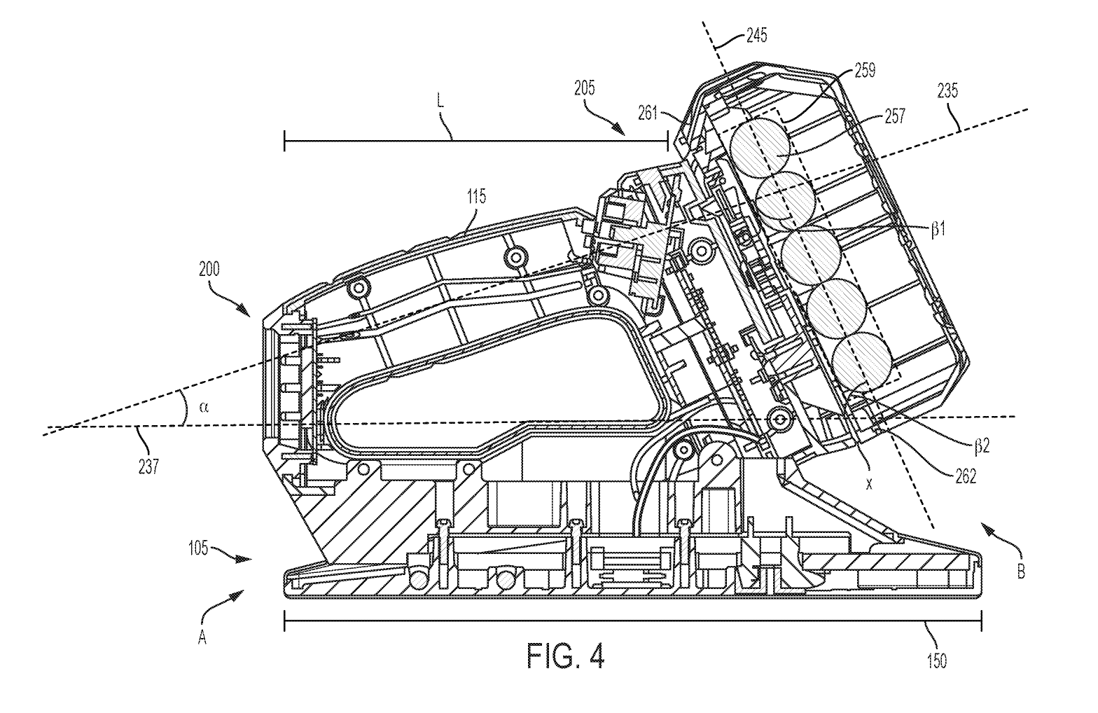

The grip portion 210 is supported by the base 170 and defines a cavity 230 to accept a user's hand. A length 232 of the grip portion 210 is sufficiently long to accommodate a wide variety of hand sizes. In the illustrated embodiment the length 232 of the grip portion 210 is approximately 6 inches. The grip portion 210 is positioned at an oblique angle with respect to the base 170 and the base plate 120. In other words, as shown in FIG. 4, a grip longitudinal axis 235 that extends through the grip portion is at a first angle α with respect to a horizontal axis 237 that is parallel to the base plate 120. In particular, the first angle α is an acute angle relative to the base plate 120. In the illustrated embodiment, the first angle α is approximately 17 degrees, and the first angle α may vary between, for example, 7 degrees and 27 degrees. The grip longitudinal axis 235 extends along the largest dimension of the grip portion 210, that is, the grip longitudinal axis 235 extends along a length of the grip portion 210, as shown in FIG. 4. The grip longitudinal axis 235 may also be referred to generally as the longitudinal axis 235 of the handle 115. The horizontal axis 237 extends along the length 150 of the iron 105 in parallel with the bottom surface of the base plate 120, and is illustrated offset above the base plate 120. The horizontal axis 237 represents a longitudinal axis of the base plate 120, as it runs parallel thereto, and is illustrated offset above the base plate 120 merely to better illustrate the angles between the longitudinal axis 237 of the base plate 120 and the other axes illustrated in FIG. 4. A heat setting actuator 240 is supported on the grip portion 210. As discussed in further detail below, the heat setting actuator 240 allows a user to indicate a target temperature for the base plate 120. In the illustrated embodiment, the heat setting actuator 240 includes a rotating dial. In other embodiments, the heat setting actuator 240 may include other types of input mechanisms such as, for example, push buttons, toggle switches, virtual buttons, and the like. In the illustrated embodiment, the heat setting actuator 240 is positioned at an end of the grip portion 210 closest to the battery receiving portion 215 (e.g., and furthest from the base 170). Such a position of the heat setting actuator 240 allows for one-handed operation of the carpet seamer 100 since a user can hold and control the carpet seamer 100 while also changing the heat setting via the heat setting actuator 240. For example, the user can change the heat setting using his/her thumb while holding the carpet seamer 100 at the grip portion 210.

The battery receiving portion 215 is coupled to, and between, the grip portion 210 and the base 170. As shown in FIG. 4, a longitudinal axis 245 of the battery receiving portion 215 is positioned at a second oblique angle β1 relative to the grip portion 210 and at a third angle β2 relative to the base plate 120. In the illustrated embodiment, the second angle β1 is substantially a right angle (e.g., the third angle β2 measures approximately 90 degrees). In some embodiments, the second angle β1 may vary slightly between, for example, 80 degrees and 100 degrees while remaining substantially a right angle. For example, in the illustrated embodiment, the second angle β1 is 96 degrees. The third angle β2 is an acute angle. In the illustrated embodiment, the third angle β2 measures 67 degrees, but may vary in some embodiments between, for example, 57 degrees and 77 degrees.

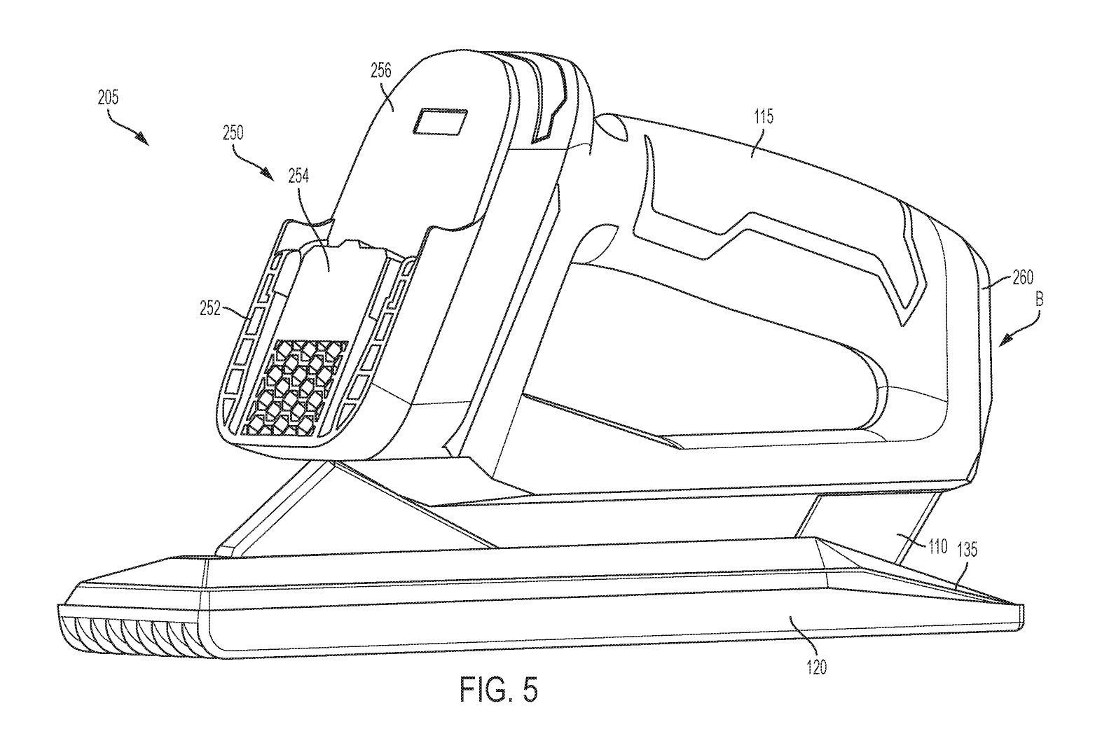

The battery receiving portion 215 includes a battery pack interface 250 shown in FIG. 5. The battery pack interface 250 includes physical structural components that secure a battery pack 255 (FIG. 1) to the battery receiving portion 215 such as, for example, rails 252. The battery pack interface 250 also includes an electrical connecting portion 254. The electrical connecting portion 254 houses electrical connectors to provide and receive power from the battery pack 255. The battery receiving portion 215 also includes a supporting face 256 that has a complementary shape to that of the battery pack 255 and receives the battery pack 255. The longitudinal axis 245 of the battery receiving portion 215 extends along the largest dimension of the battery receiving portion 215. That is, the longitudinal axis 245 of the battery receiving portion 215 extends along a length of the battery receiving portion 215.

In the illustrated embodiment, the battery pack 255 includes releasably attachable battery pack that can be removed from the carpet seamer 100, for example, for charging the battery pack 255, and secured to the carpet seamer 100, for example, to power a carpet seaming operation. The battery pack 255 includes an attachment mechanism, such as, for example, latches, that secure the battery pack 255 to the battery receiving portion 215 via, for example, the rails 252. In the illustrated embodiment, the battery pack 255 is a slide-on battery pack that engages with the battery pack interface 250 by sliding the battery pack 255 along the longitudinal axis 245. In other embodiments, however, different types of battery packs may be used to power the carpet seamer 100. For example, a post style battery pack may be used with the carpet seamer 100. In such embodiments, the battery receiving portion 250 may also include a cavity to receive the post of the battery pack. Additionally, the post style battery pack may not need the rails 252 and may instead of a different type of latching mechanism.

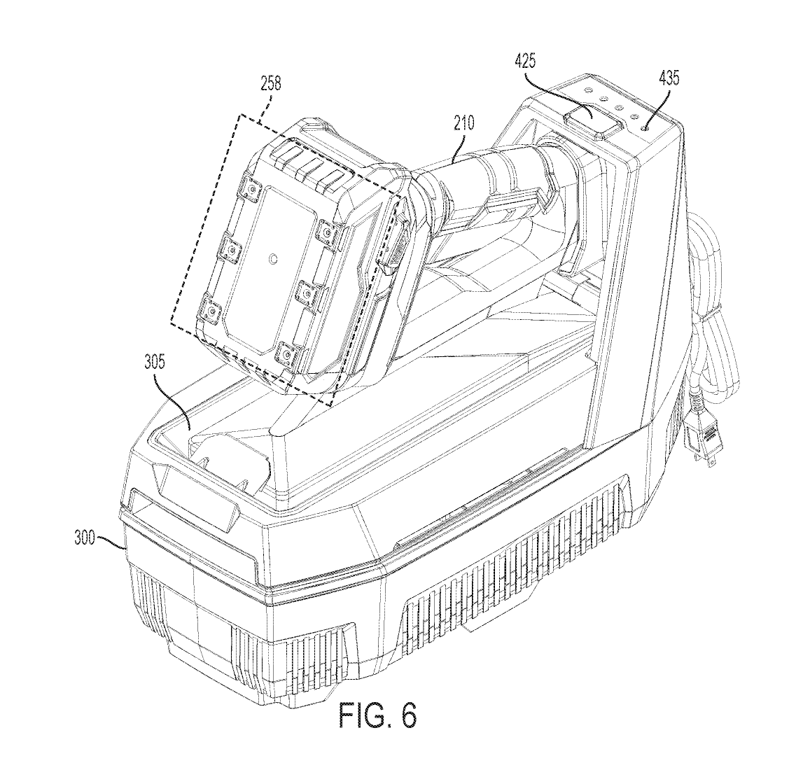

The battery pack 255 includes a plurality of battery cells 257 that provide power to the carpet seamer 100. As shown in FIG. 4, each battery cell 257 is positioned such that a length (e.g., the longest dimension of the battery cell 257) extends along the width 155 of the carpet seamer 100. In the illustrated embodiment, the battery cells 257 define a plane 258 (see FIG. 6) that is substantially parallel to the supporting face 256 of the battery receiving portion 215, and parallel to the longitudinal axis 245 of the battery receiving portion 215, and substantially parallel to the longitudinal axis 245 of the battery receiving portion 215. The plane 258 is also tangential to the rear-facing, radially outer surfaces of the battery cells 257 and substantially perpendicular to the longitudinal axis 235 of the grip portion 210. In the illustrated embodiment, a second end plane 259 bisects the battery cells 257, with each longitudinal axis of the battery cells 257 (not shown, but extending out of the page of FIG. 4) being normal to the second plane 259. The longitudinal axis 245 of the battery receiving portion bisects the second end plane 259.

As discussed above, the rising base portion 225 slopes upward. The upward slope of the rising base portion 225 and the angled longitudinal axis 245 of the battery receiving portion 215 allow the battery receiving portion 215 to be separated from the iron 105 (more specifically, from the top plate 135) by a greater distance than that which separates the base 170 from the top plate 135. The increased distance between the battery receiving portion 215 and the iron 105 helps shield the battery pack 255 from the heat generated by the iron 105 and thereby protects the battery pack 255. Additionally, because the battery receiving portion 215 is angled toward the front side A of the iron 105 (e.g., because the third angle β2 is acute), the weight of the battery pack 255 is more evenly distributed along the entire length of the carpet seamer 100, instead of being concentrated on the back side B of the carpet seamer 100.

As shown in FIGS. 4 and 5, a length L of the handle 115 is shorter than the length 150 of the iron 105. Because the front end 200 of the handle 115 is aligned with the front side A of the carpet seamer 100, the back end 205 of the handle 115 does not reach the back side B of the carpet seamer 100. Stated another way, the rearmost portion of the battery pack 255 is entirely forward of the rearmost portion of the iron 105. The shorter length L of the handle 115 with respect to the iron 105 and the angled longitudinal axis 245 of the battery receiving portion 215 allow the battery pack 255, when coupled to the battery receiving portion 215, to be positioned above the iron 105 and such that the plurality of battery cells 257 are within a footprint defined by a perimeter P of the iron 105. Accordingly, the iron 105 provides partial support to the battery pack 255 when the battery pack 255 is coupled to the battery receiving portion 215. Such a positioning of the battery pack 255 inhibits the weight of the battery pack 255 from tipping the carpet seamer 100 over toward the back side B of the carpet seamer 100. In other words, the weight of the battery pack 255 is more evenly distributed due to the angled longitudinal axis 245 of the battery receiving portion 215 and the shorter length L of the handle 115 with respect to the iron 105. For example, if the battery receiving portion 215 extended beyond the back side B of the iron 105, the weight of the battery pack 255 would be more likely to cause the carpet seamer 100 to tip over toward the back side B of the iron. Similarly, if the longitudinal axis 245 of the battery pack receiving portion 215 were substantially perpendicular to the base plate 120, the carpet seamer 100 would be more likely to tip over toward the back side B of the iron due to the less evenly distributed weight of the battery pack 255.

Additionally, as shown in FIG. 4, the base 170, the grip portion 210, and the battery receiving portion 215 form a substantially triangular shape (as shown, for example, by the longitudinal axes 235, 237, 245) defined by the first angle α, the second angle β1, and the third angle β2. Each of the first angle α, the second angle β1, and the third angle β2 measure less than 120 degrees, and the second angle β1 is the largest angle at approximately 96 degrees. The triangular shape of the handle 115 is such that, when the battery pack 255 is coupled to the battery receiving portion 215, a front top portion 261 of the battery pack 255 is positioned further forward than a rear bottom portion 262 of the battery pack 255. The center of gravity of the battery pack 255, when attached to the battery receiving portion 215, is forward of the bottom lower point X and is forward of the rearmost portion of the iron 105, as shown in FIG. 4.

Referring back to FIG. 1, a base station interface 260 is coupled to the front end 200 of the handle 115. In particular, the base station interface 260 is positioned at an interface between the base 170 and the grip portion 210. The base station interface 260 includes an engagement face 263 that is positioned substantially perpendicular to the base plate 120 (i.e., positioned at an angle between 80 degrees and 100 degrees relative to the base plate 120). As shown in FIG. 3, the base station interface 260 extends beyond the front side A of the iron 105. FIG. 6 illustrates the carpet seamer 100 coupled to a base station 300. The base station 300 provides power to the battery pack 255, or directly to the carpet seamer 100, as discussed in more detail below. In the illustrated embodiment, the carpet seamer 100 is coupled to the base station 300 via a tray 305. The tray 305 and the carpet seamer 100 each include a latching mechanism to secure the tray 305 and the carpet seamer 100 to the base station 300.

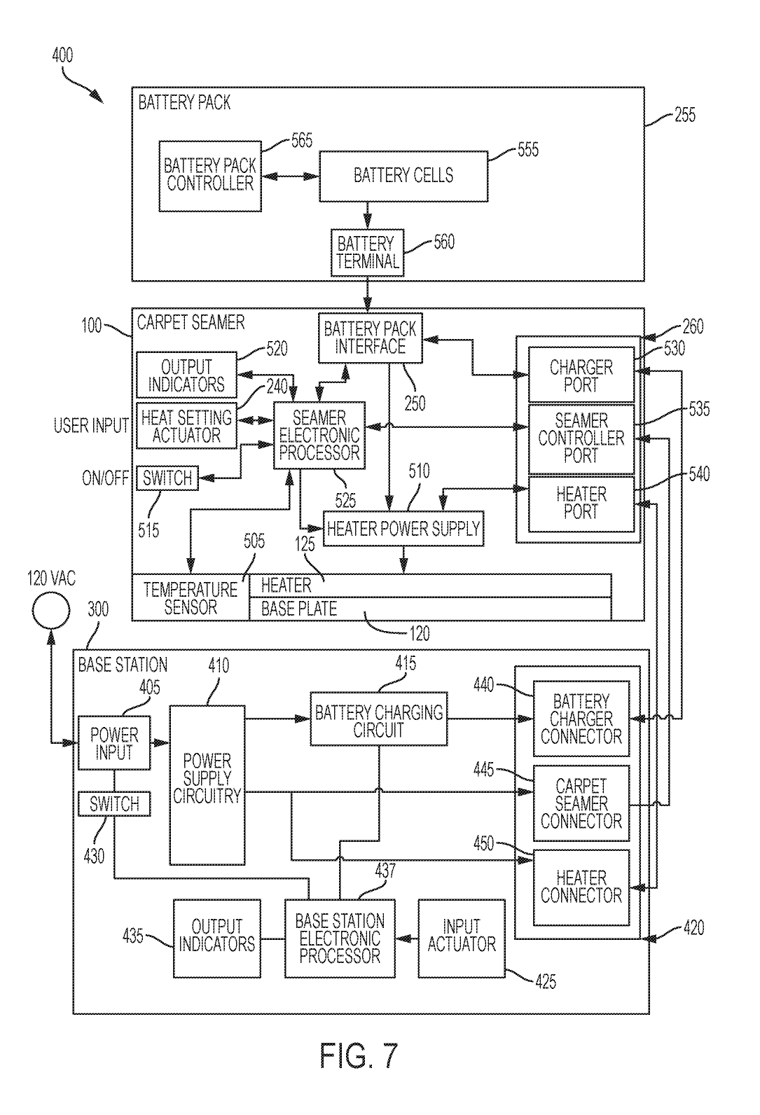

FIG. 7 is a block diagram of a carpet seaming system 400 including the base station 300, the carpet seamer 100, and the battery pack 255. As shown in FIG. 7, the base station 300 includes a power input 405, power supply circuitry 410, a battery charging circuit 415, a carpet seamer interface 420, an input actuator 425, a power switch 430, output indicators 435, and a base station electronic processor 437. The power input 405 receives alternating current (AC) power from an external source, such as, a wall outlet. The power input 405 then transfers the received power to the power supply circuitry 410. The power supply circuitry 410 adapts the input power for use by the battery charging circuit 415 and other elements of the base station 300. For example, the power supply circuitry may include an AC-to-DC converter, a step-down controller, and the like. The battery charging circuit 415 is coupled to the power supply circuitry 410 and to the carpet seamer interface 420. The battery charging circuit 415 redistributes power from the power supply circuitry 410 to the carpet seamer interface 420. In particular, the battery charging circuit 415 adapts the power from the power supply circuitry 410 to adequately charge the battery pack 255. Additionally, the battery charging circuit 415 may implement specific charging algorithms to efficiently charge the battery pack 255.

The carpet seamer interface 420 electrically connects the base station 300 with the carpet seamer 100 via the base station interface 260. In particular, the carpet seamer interface 420 includes a battery charger connector 440, a carpet seamer connector 445, and a heater connector 450. The battery charger connector 440 is coupled to the battery charging circuit 415 and transfers power from the battery charging circuit 415 to the battery pack 255 via the base station interface 260. The carpet seamer connector 445 is coupled to a seamer electronic processor 525. The carpet seamer connector 445 transfers power from the power supply circuitry 410 to the seamer electronic processor 525 via the base station interface 260. The heater connector 450 is coupled to the heater 125 and provides power to the heater 125 to heat the base plate 120 when, for example, the battery pack 255 is disconnected from the battery receiving portion 215.

The input actuator 425 is a user-operable actuator to control the operation of the base station 300 and the operation of the carpet seamer 100. The input actuator 425 may include, for example, a push button, a toggle switch, a rotary knob, and the like. In some embodiments, the input actuator 425 is used to selectively engage and disengage a locking mechanism that secures the carpet seamer 100 to the base station 300. For example, a user may press the input actuator 425 to release the locking mechanism and thereby release the carpet seamer 100 from the base station 300.

The power switch 430 includes, for example, a toggle switch. The state of the power switch 430 affects the operation of the base station 300 and controls the power distribution from the external power supply to the carpet seamer 100, the battery pack 255, or both. For example, the state of the power switch 430 may determine whether the battery pack 255 is charged via the base station 300, and whether the heater 125 will be activated from power from the base station 300. In the illustrated embodiment, the power switch 430 is a toggle switch that is movable between an on state and an off state. The output indicators 435 may include, for example, LEDs or similar elements that can produce an output to the user. In particular, the output indicators 435 may communicate a variety of information to the user. In one example, the output indicators 435 may indicate the state of charge of the battery pack 255 when the battery pack 255 is coupled to the battery pack receiving portion 215 and the carpet seamer 100 is coupled to the base station 300. In another example, the output indicators 435 may indicate the state of heat achieved by the base plate 120 or the heater 125. For example, the output indicators 435 may indicate a difference between the current temperature of the base plate 120 and a target temperature. Additionally or alternatively, the output indicators 435 may help the user identify when the base plate 120 has reached the target temperature.

The base station 300 also includes the base station electronic processor 437. The base station electronic processor 437 is coupled to the battery charging circuit 415, the input actuator 425, the power switch 430, the output indicators 435, and the power supply circuitry 410. The base station electronic processor 437 may additionally be coupled to a memory storing instructions to be retrieved and executed by the base station electronic processor 437. In some embodiments, the base station electronic processor 437 may be implemented in hardware (e.g., an application specific integrated circuit (ASIC) or field programmable gate array). The base station electronic processor 437 receives input signals from, for example, the input actuator 425 and the power switch 430, and, in response, controls distribution of the power from the power supply circuitry 410. In some embodiments, the base station electronic processor 437 also receives input signals from the carpet seamer 100 indicating, for example, a current state of charge of the battery pack 255, a signal indicating whether the battery pack 255 is coupled to the carpet seamer 100, and the current temperature of the iron 105. The base station electronic processor 437 may then determine, based on the input signals from the carpet seamer 100, the input actuator 425, and the power switch 430, whether to transmit power to the carpet seamer 100, and which one or more connectors of the connectors 440, 445, 450 use to transfer the power to the carpet seamer 100.

As discussed above, the carpet seamer 100 electrically connects with the base station 300 via the base station interface 260 and the carpet seamer interface 420. As shown in FIG. 7, the carpet seamer 100 also includes the battery pack interface 250, the heater 125, a temperature sensor 505, a heater power supply 510, the heat setting actuator 240, a power switch 515, output indicators 520, and a seamer electronic processor 525. The battery pack interface 250 includes electrical connectors that electrically connect the battery cells of the battery pack 255 with the carpet seamer 100. The battery pack 255 may provide power from its battery cells to the carpet seamer 100 to activate the heater 125. The battery pack 255 may also receive power from the battery pack interface 250. In particular, the battery pack 255 receives power from the battery pack interface 250 via the base station interface 260.

As shown in FIG. 7, the base station interface 260 includes a charger port 530, a seamer controller port 535, and a heater port 540. The charger port 530 is electrically coupled to the battery charger connector 440, and receives power from the base station 300 through the battery charger connector 440. The charger port 530 is also coupled to the battery pack interface 250 and can therefore transmit the power from the charger port 530 to the battery pack 255. The seamer controller port 535 is electrically coupled to the carpet seamer connector 445, and receives power from the base station 300 through the carpet seamer connector 445. The seamer controller port 535 is also coupled to the seamer electronic processor 525 to provide sufficient power to activate the seamer electronic processor 525. The heater port 540 is electrically coupled to the heater connector 450, and receives power from the base station 300 through the heater connector 450. The heater connector 450 is configured to provide power to the heater 125 via the heater port 540, for example, when the battery pack 255 is not coupled to the battery pack receiving portion 215.

The heater power supply 510 controls the power provided to the heater 125. The heater power supply 510 is coupled to the battery pack interface 250, the base station interface 260, and the seamer electronic processor 525. The heater power supply 510 selectively receives power from the battery pack 255 through the battery pack interface 250 and from the external AC source through the base station interface 260. In some embodiments, the heater power supply 510 receives a control signal from the seamer electronic processor 525 indicating whether power is to be provided to the heater 125. The heater power supply 510 then provides and interrupts power to the heater 125 based on the control signal from the seamer electronic processor 525.

The temperature sensor 505 is positioned in the iron 105 and generates an output temperature signal indicative of the temperature of the base plate 120. The temperature sensor 505 is coupled to the seamer electronic processor 525 and provides the output temperature signal to the seamer electronic processor 525. The heat setting actuator 240 is coupled to the seamer electronic processor 525. The heat setting actuator 240 provides a signal to the seamer electronic processor 525 indicating a target temperature for the base plate 120. As discussed above, the user may manipulate the heat setting actuator 240 to set a target temperature based on, for example, the type of carpet seaming tape used. The carpet seamer 100 also includes the power switch 515, which turns the carpet seamer 100 on and off. In some embodiments, the power switch 515 may be incorporated into the heat setting actuator 240. For example, a far right position on the rotating dial of the heat setting actuator 240 may correspond to the power switch 515 being in the on position while a far left position on the rotating dial of the heat setting actuator 240 may correspond to the power switch 515 being in the off position. In other embodiments, the heat setting actuator 240 and the power switch 515 correspond to different physical actuators on the carpet seamer 100. The output indicators 520 generate an output signal indicating to the user the state of the carpet seamer 100. In the illustrated embodiment, the output indicators 520 may indicate whether the heater 125 is activated and whether the heater 125 has reached the target temperature. In one particular example, the output indicators 520 include one or more LEDs. The LEDs are deactivated (e.g., off) when the heater 125 is not activated. In some embodiments, the one or more LEDs flash when the heater 125 is activated but has not reached the target temperature, and the one or more LEDs are continuously activated (e.g., on without flashing) when the heater 125 is activated and has reached the target temperature.

The seamer electronic processor 525 is coupled to the battery pack interface 250, the base station interface 260, the heater power supply 510, the temperature sensor 505, the heat setting actuator 240, the power switch 515, and the output indicators 520. The seamer electronic processor 525 may be implemented by a microprocessor executing instructions stored in a coupled memory. In other embodiments, the seamer electronic processor 525 may be implemented partially or entirely on a semiconductor (e.g., a field-programmable gate array [“FPGA”] semiconductor) chip. In other embodiments, the seamer electronic processor 525 may be implemented as an application specific integrated circuit (ASIC). The seamer electronic processor 525 receives power from either the battery pack interface 250, the base station interface 260 based on the power available from the battery pack, or both. For example, when the battery pack 255 is coupled to the battery pack interface 250 and the state of charge of the battery pack 255 exceeds a low voltage threshold, the seamer electronic processor 525 determines that the battery pack 255 can supply power to the heater 125.

As shown in FIG. 7, the battery pack 255 includes a plurality of battery cells 555, a battery terminal 560, and a battery pack controller 565. The battery pack controller 565 is coupled to the battery cells 555 and monitors various conditions of the battery cells 555 such as, for example, a current state of charge, a temperature, current provided by the battery cells 555, and the like. The battery terminal 560 is coupled to the battery cells 555 and electrically connects the battery cells 555 with the carpet seamer 100, the base station 300, or both. In particular, the battery terminal 560 provides power from the battery cells 555 to the carpet seamer 100 to, for example, heat the iron 105. The battery terminal 560 may also provide power to the battery cells 555 from an external AC source through the base station interface 260 and the carpet seamer interface 420. In some embodiments, the battery charging circuit 415 controls a charging algorithm for providing power to the battery cells 555 through the battery terminal 560. In other embodiments, the seamer electronic processor 525 controls the charging algorithm for the battery pack 255, and in yet other embodiments, the battery pack controller 565 controls the charging algorithm for the battery pack 255 and communicates specific charging requirements and/or commands to the carpet seamer 100, the base station 300, or both.

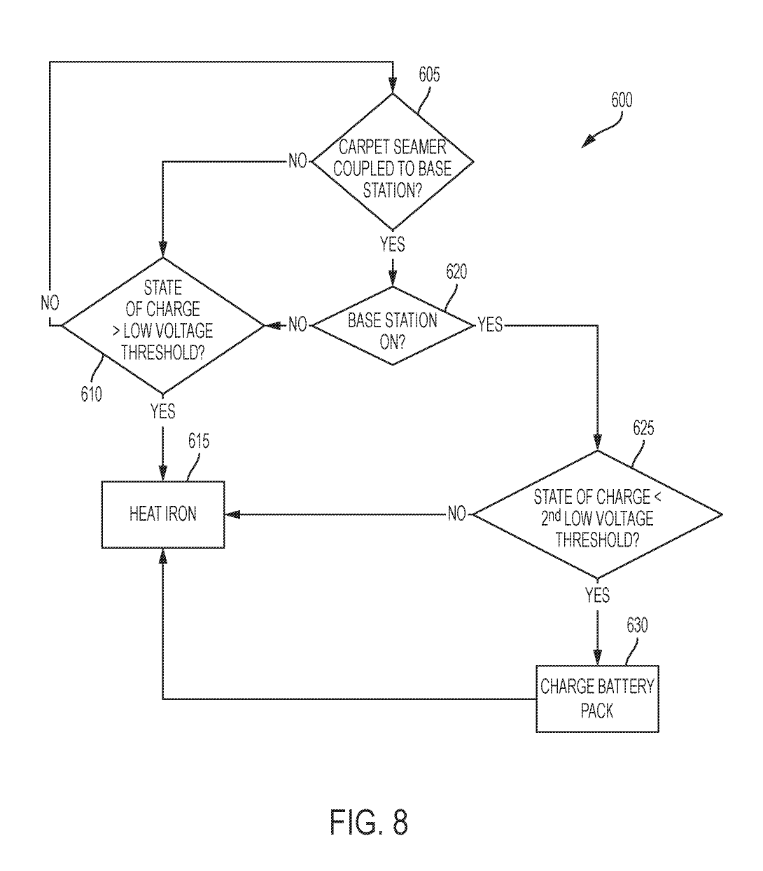

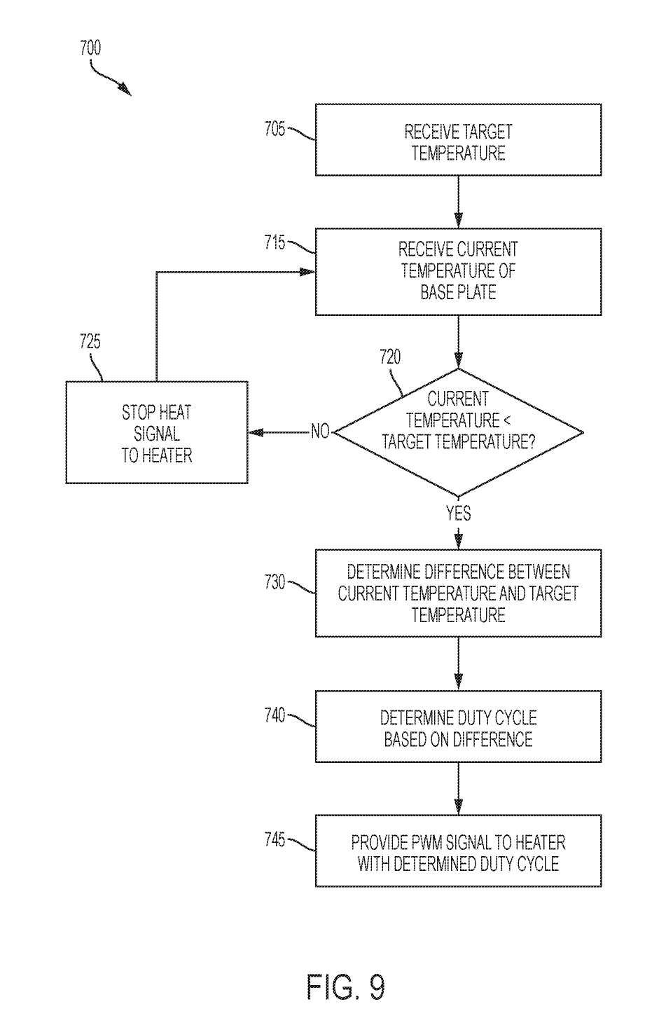

FIG. 8 illustrates a method 600 of operating the carpet seaming system 400. In step 605, the seamer electronic processor 525 determines whether the carpet seamer 100 is coupled to the base station 300. For example, the seamer electronic processor 525 analyzes the signals, or lack of signals, at the base station interface 260 to determine whether the carpet seamer 100 is coupled to the base station 300. When the seamer electronic processor 525 determines that the carpet seamer 100 is not coupled to the base station 300, the seamer electronic processor 525 proceeds to determine whether the state of charge of the battery pack 255 exceeds the low voltage threshold (step 610). For example, the battery pack 255 may transmits a signal to the seamer electronic processor 525 indicating a current state of charge of the battery pack 255. In other embodiments, the seamer electronic processor 525 may determine the state of charge of the battery pack 255 based on the voltage signals from the battery terminal 560. When the state of charge of the battery pack 255 is at or below the low voltage threshold, the seamer electronic processor 525 returns to step 605 and waits for the carpet seamer 100 to be coupled to the base station 300. On the other hand, when the state of charge of the battery pack 255 exceeds the low voltage threshold, the seamer electronic processor 525 heats the iron 105 (step 615). In particular, the seamer electronic processor 525 controls a pulse-width-modulated (PWM) signal to provide energy to the heater 125 to heat the base plate 120, as discussed in further detail below with respect to FIG. 9.

Referring back to step 605, when the seamer electronic processor 525 determines that the carpet seamer 100 is coupled to the base station 300, the seamer electronic processor 525 then determines whether the base station 300 is powered on (step 620). The seamer electronic processor 525 may determine that the base station 300 is powered when, for example, the carpet seamer 100 receives power through the base station interface 260. When the seamer electronic processor 525 determines that the base station 300 is currently not powered, the seamer electronic processor 525 proceeds to step 610 to determine whether the battery pack 255 holds sufficient charge to heat the iron 105. On the other hand, when the seamer electronic processor 525 determines that the base station 300 is powered, the seamer electronic processor 525 determines whether the battery pack 255 is below a second low voltage threshold (step 625).

In the illustrated embodiment, the second low voltage threshold is higher than the low voltage threshold referenced in step 610. When the seamer electronic processor 525 determines that the state of charge of the battery pack 255 (e.g., the battery voltage) is below the second low voltage threshold, the seamer electronic processor 525 proceeds to charge the battery pack 255 using the power received from the base station 300 via the base station interface 260 (step 630). When the seamer electronic processor 525 determines that the state of charge of the battery pack 255 (e.g., the battery voltage) is above the second low voltage threshold, the seamer electronic processor 525 proceeds to heat the iron 105 (step 615). In the illustrated embodiment, the seamer electronic processor 525, also proceeds to step 615 to heat the iron 105 after determining that the battery pack 255 is to be charged. In other words, in the illustrated embodiment, the carpet seamer 100 may receive power from the base station 300 to simultaneously heat the iron 105 and charge the battery pack 255.

FIG. 9 illustrates a method 700 of heating the carpet seamer 100 as discussed above with respect to step 615. In step 705, the seamer electronic processor 525 receives a target temperature from the heat setting actuator 240. The seamer electronic processor 525 also receives the output temperature signal from the temperature sensor 505 indicating the current temperature of the base plate 120 (step 715). The seamer electronic processor 525 then determines whether the current temperature of the base plate 120 is below the target temperature (step 720). When the seamer electronic processor 525 determines that the current temperature of the base plate 120 is at the target temperature or exceeds the target temperature, the seamer electronic processor 525 stops a heat signal to the heater 125 (step 725). For example, the seamer electronic processor 525 may send a stop signal to the heater power supply 510 such that the heater 125 stops heating the base plate 120. The electronic processor 525 continues to monitor the current temperature of the base plate 120 relative to the target temperature (step 710).

On the other hand, when the seamer electronic processor 525 determines that the current temperature of the base plate 120 is below the target temperature, the seamer electronic processor 525 determines a difference between the current temperature of the base plate 120 and the target temperature (step 730). The seamer electronic processor 525 then determines a duty cycle based on the determined difference between the current temperature of the base plate 120 and the target temperature (step 740). The seamer electronic processor 525 then provides a power pulse-width-modulated (PWM) signal to the heater power supply 510 according to the determined duty cycle to heat the iron 105 (step 745). The heater power supply 510 includes one or more switching elements that are driven by the PWM signal to selectively provide power to the heater 125 in accordance with the duty cycle of the PWM signal. In some embodiments, the seamer electronic processor 525 determines the duty cycle and transmits the determined duty cycle to the heater power supply 510 to implement.

In particular, the heater power supply 510 increases the duty cycle of the PWM signal as the difference between the current temperature and the target temperature increases. The heater power supply 510 may determine the duty cycle of the PWM signal by referring to a look-up table identifying various temperature differences and the corresponding duty cycles. For example, when the current temperature of the base plate 120 is 50 degrees Fahrenheit lower than the target temperature (i.e., a first temperature difference), the heater power supply 510 provides a PWM signal to the heater 125 with a 60% duty cycle. However, when the current temperature of the base plate 120 is only 5 degrees Fahrenheit lower than the target temperature (i.e., a second, lower temperature difference), the heater power supply 510 provides a PWM signal to the heater 125 with a 20% duty cycle. Providing a PWM signal to the heater 125 with an adjustable duty cycle based on the current-to-target temperature difference increases the battery life of the battery pack 255. Accordingly, when the carpet seamer 100 is in a carpet seaming operation in which the battery pack 255 heats the iron 105, the operation time of the carpet seamer 100 may be extended by providing a PWM signal instead of a continuous power signal. Additionally, providing the PWM signal to the heater 125 also allows the seamer electronic processor 525 to control the amount of power that is provided to the heater 125 and, therefore, maintain the temperature of the base plate 120 at the target temperature more accurately.

Various features and advantages of the invention are set forth in the following claims.

What is claimed is:

1. A carpet seamer comprising:
an iron including a base plate and a heater configured to transmit heat to the base plate;
a handle having a first end and a second end opposite the first end, the second end facing a direction of travel of the carpet seamer when the carpet seamer is in operation;
a neck connecting the iron with a lower portion of the handle;
a battery receiving portion positioned at the second end of the handle, the battery receiving portion configured to receive a releasably attachable battery pack; and
a seamer electronic processor coupled to the heater, the seamer electronic processor configured to:
control the heater to selectively receive power from the battery pack.

2. The carpet seamer of claim 1, wherein the iron has a first length and the handle has a second length shorter than the first length, and wherein the first end of the handle is aligned with a front edge of the iron.

3. The carpet seamer of claim 1, further comprising a base station interface positioned at the first end of the handle, the base station interface configured to couple to a base station to receive power from the base station.

4. The carpet seamer of claim 1, wherein a longitudinal axis of the handle is at an acute angle relative to the base plate.

5. The carpet seamer of claim 1, wherein a longitudinal axis of the battery receiving portion extends at an acute angle relative to the base plate, and at an angle between 80 degrees and 100 degrees relative to the longitudinal axis of the handle.

6. The carpet seamer of claim 1, wherein the second end of the handle is positioned higher relative to the base plate than the first end of the handle.

7. The carpet seamer of claim 1, wherein a rearmost portion of the battery pack is frontward of a rearmost portion of the iron.

8. The carpet seamer of claim 1, wherein the battery pack includes a plurality of battery cells, and wherein, when the battery pack is coupled to the battery receiving portion, the battery cells are positioned above the iron and within a footprint defined by a perimeter of the iron.

9. The carpet seamer of claim 1, further comprising a heat setting actuator coupled to the handle and switchable between different states to indicate a target temperature of the heater.

10. The carpet seamer of claim 9, wherein the seamer electronic processor is configured to generate a pulse-width-modulated signal to control the heater based on a state of the heat setting actuator.

11. A carpet seamer comprising:
an iron including a base plate and a heater configured to transmit heat to the base plate;
a handle coupled to the iron, the handle including a first portion substantially parallel to the base plate, a grip portion coupled to the first portion and positioned at a first oblique angle relative to the base plate, and a battery receiving portion coupled to the grip portion and the first portion and positioned at a second oblique angle relative to the base plate, the first oblique angle being different than the second oblique angle, the battery receiving portion configured to receive a battery pack; and
a seamer electronic processor coupled to the heater, and configured to generate a control signal to control the heater to selectively receive power from the battery pack.

12. The carpet seamer of claim 11, further comprising a base station interface positioned opposite the battery receiving portion, and at an interface between the first portion and the grip portion of the handle.

13. The carpet seamer of claim 12, wherein the base station interface includes an engagement face that is substantially perpendicular to the base plate.

14. The carpet seamer of claim 11, further comprising a heat setting actuator to indicate a target temperature for the heater, the heat setting actuator positioned on the grip portion.

15. The carpet seamer of claim 14, wherein the control signal includes a pulse-width-modulated signal, and wherein the seamer electronic processor determines a duty cycle of the control signal based on a state of the heat setting actuator.

16. The carpet seamer of claim 15, wherein the iron further includes a temperature sensor, and wherein the seamer electronic processor determines the duty cycle based on the state of the heat setting actuator and on an output signal from the temperature sensor.

17. The carpet seamer of claim 11, wherein the first portion of the handle is separated from the iron by a first distance, and a lowermost section of the battery receiving portion of the handle is separated from the iron by a second distance, and wherein the second distance is longer than the first distance.

18. The carpet seamer of claim 11, wherein a rearmost portion of the battery pack is frontward of a rearmost portion of the iron.

19. The carpet seamer of claim 11, wherein the battery pack, when connected to the battery receiving portion, is positioned above the iron and within a footprint defined by a perimeter of the iron.

20. The carpet seamer of claim 11, wherein the iron further includes an insulation layer between the heater and the handle.
